(19) United States
(12) Patent Application Publication
(10) Pub. No.: US 2019/0077919 A1
(43) Pub. Date: Mar. 14, 2019

(54) METHOD FOR SULFONATING POLYMERS

(71) Applicant: BASF SE, Ludwigshafen am Rhein (DE)

(72) Inventors: Christian MALETZKO, Ludwigshafen am Rhein (DE); Axel WILMS, Frankenthal (DE); Tobias HOEFENER, Düsseldorf-Holthausen (DE)

(21) Appl. No.: 16/083,220

(22) PCT Filed: Mar. 7, 2017
(86) PCT No.: PCT/EP2017/055326

§ 371 Date: Sep. 7, 2018

(30) Foreign Application Priority Data
Mar. 9, 2016 (EP) 16159497.3

(51) Int. Cl. C08G 75/02; C08G 75/23; C08G 75/0281; B01D 71/68

(52) U.S. Cl. CPC C08G 75/0272; B01D 71/68; C08G 75/0281; C08G 75/23

(57) ABSTRACT

The present invention relates to a method of forming a sulfonated aromatic polymer, to the sulfonated aromatic polymer thus formed and to the method of using the sulfonated aromatic polymer in the manufacture of membranes.

The present invention relates to a method of forming a sulfonated aromatic polymer, to the sulfonated aromatic polymer thus formed and to the method of using the sulfonated aromatic polymer in the manufacture of membranes.

Aromatic polymers in general and polyarylene ether sulfone polymers in particular are high-performance thermoplastics in that they feature high heat resistance, good mechanical properties and inherent flame resistance (E. M. Koch, H.-M. Walter, Kunststoffe 80, (1990) 1146; E. Döring, Kunststoffe 80, (1990) 1149; N. Inchaurondo-Nehm, Kunststoffe 98, (2008) 190). Polyarylene ether sulfones are highly biocompatible and so are also used as a material for forming dialysis membranes. Specifically sulfonated polyarylene ether sulfone polymers are useful in the manufacture of membranes and films, for example for ultrafiltration processes and microfiltration processes and also for reverse osmosis, forward osmosis and ion exchange. The prior art includes descriptions of various methods of forming sulfonated aromatic polymers, specifically polyarylene ether sulfones.

DE 11 2012 005 418 describes a method of forming a sulfonated aromatic polymer wherein an aromatic polymer is sulfonated with a sulfonating agent such as chlorosulfonic acid, sulfuric anhydride, sulfuric acid, fuming sulfuric acid or polyalkylbenzenesulfonic acids, in the presence of a solvent selected from sulfolane and dimethyl sulfone. The aromatic polymers described are aromatic polyamides, aromatic polyimides, aromatic polyether ketones, aromatic polyether ether ketones, aromatic polycarbonates, aromatic polysulfones, aromatic polysulfoxides, aromatic polysulfides, aromatic polyether sulfones, aromatic polyether ether sulfones, aromatic polyesters and polystyrenes.

C. Klaysom et al., Journal of Membrane Science 368 (2011) 48-53 describe the Sulfonation of polyether sulfone with chlorosulfonic acid in the presence of dichloromethane.

J. F. Blanco, Journal of Applied Polymer Science, Volume 84 (2002) 2461-2473 describe the sulfonation of polyether sulfone with sulfur trioxide in the presence of sulfuric acid as solvent and also the sulfonation with chlorosulfonic acid in dichloroethane as solvent.

U.S. Pat. No. 2,809,959 describes a method of sulfonating vinylaromatic hydrocarbon polymers. Said sulfonating is effected with chlorosulfonic acid in the presence of sulfur dioxide as solvent.

U.S. Pat. No. 2,691,644 likewise describes a method of sulfonating aromatic polymers such as polystyrene. The solvent used is a mixture of sulfur dioxide and a chlorinated aliphatic hydrocarbon. The sulfonating agent used is sulfur trioxide.

One disadvantage with the prior art methods of forming sulfonated aromatic polymers is that the aromatic polymer is frequently degraded by chain scission, changing the chain length of the polymer and hence also its properties. In addition, after the sulfonated aromatic polymer has been separated off, the methods all leave behind either an acidic solvent or an organic solvent, which in either case have to be burdensomely worked up for reuse in the sulfonation process.

The present invention therefore has for its object to provide a method of forming a sulfonated aromatic polymer that does not retain the disadvantages of the prior art methods of forming sulfonated aromatic polymers, or only in diminished form.

We have found that this object is achieved by the method of forming a sulfonated aromatic polymer by reacting an aromatic polymer with at least one sulfonating agent in the presence of a solvent comprising sulfur dioxide.

We have further found that this object is achieved by the method of forming a sulfonated aromatic polymer by reacting an aromatic polymer with at least one sulfonating agent in the presence of a solvent comprising sulfur dioxide, where the aromatic polymer is a polyarylene ether comprising building blocks of general formula (I)

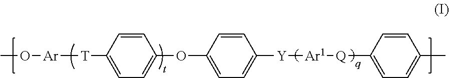

where
t and q are each independently 0, 1, 2 or 3,
Q, T and Y are each independently a chemical bond or a group selected from —O—, —S—, —SO₂—, S═O, C═O, —N═N— and —CR^{a}R^{b}—, where R^{a} and R^{b} are each independently a hydrogen atom or a C₁-C₁₂ alkyl, C₁-C₁₂ alkoxy or C₆-C₁₈ aryl group, and
Ar and Ar¹ are each independently an arylene group having from 6 to 18 carbon atoms,

wherein the at least one sulfonating agent is selected from the group consisting of sulfur trioxide, sulfuric acid, fuming sulfuric acid and polyalkylbenzenesulfonic acids, and

wherein the solvent comprises less than 80 wt % of sulfur dioxide, based on the total weight of the solvent.

Sulfur dioxide was surprisingly found to be a very good solvent for aromatic polymers.

It was further found that, surprisingly, the aromatic polymer dissolved in sulfur dioxide is highly reactive toward sulfonating agents. A further advantage with the method of the present invention is that sulfur dioxide is easy to separate from the sulfonated aromatic polymer formed. No burdensome purification of the solvent used is accordingly required, in particular in the particularly preferred embodiment, where the solvent consists of sulfur dioxide.

It is a further advantage that no chain degradation of the aromatic polymer occurs in the method of the present invention and therefore the sulfonated aromatic polymer formed in the method of the present invention continues to have a high molecular weight.

It is also an advantage that the reaction is even performable at very low temperatures of, for example, −30 to +100° C. at a pressure in the range from 0.1 to 100 bar.

The method of the present invention will now be more particularly described,

According to the present invention, the sulfonated aromatic polymer is formed by reacting an aromatic polymer with at least one sulfonating agent in the presence of a solvent comprising sulfur dioxide.

“At least one sulfonating agent” is to be understood as meaning in the context of the present invention a mixture of two or more sulfonating agents as well as one sulfonating agent.

“A solvent” is to be understood as meaning in the context of the present invention a mixture of two or more solvents as well as one solvent. It is preferably one solvent according to the invention. In this case, it is particularly preferable according to the present invention for the solvent to consist of sulfur dioxide.

The reaction of the aromatic polymer with the at least one sulfonating agent is a sulfonation reaction, or sulfonation. The terms “reaction”, “sulfonation” and “sulfonation reaction” are accordingly used interchangeably in the context of the present invention and have the same meaning.

The reaction involved in the method of the present invention is thus a sulfonation reaction. This reaction is known per se to a person skilled in the art. A sulfonation reaction is the introduction of SO₂X groups into the aromatic polymer, in particular into the aromatic ring thereof. X in the SO₂X group is Cl or OZ, where Z is hydrogen or a cation equivalent. The term “cation equivalent” is to be understood in the context of the present invention as meaning a singly charged cation or one charge equivalent of a multiply charged cation, for example Li, Na, K, Mg, Ca, NH₄. Z is preferably selected from the group consisting of H, Li, Na, K, Ca, Mg and NH₄. An SO₂X group is preferably a sulfonic acid group (—SO₃H) or a group which reacts with water to form a sulfonic acid group. It is particularly preferable for an SO₂X group to be a sulfonic acid group (—SO₃H).

Groups which react with water to form a sulfonic acid group (—SO₃H) are known to a person skilled in the art and include, for example, chlorosulfonyl groups (—SO₂Cl).

The present invention accordingly also provides a method wherein the reaction is a sulfonation reaction wherein an SO₂X group, where X is Cl or OZ, where Z is selected from the group consisting of H, Li, Na, K, Mg, Ca and NH₄, is introduced into the aromatic polymer.

The reaction of the aromatic polymer with the at least one sulfonating agent may take place at any desired temperature. The temperature during the reaction is preferably in the range from −30 to +100° C., more preferably in the range from −10 to +20° C.

The present invention accordingly also provides a method wherein the temperature during the reaction is in the range from −30 to +100° C.

The pressure during the reaction is likewise freely choosable. The pressure during the reaction is in the range from 0.1 to 100 bar for example and in the range from 0.9 to 3.5 bar for preference,

The present invention accordingly also provides a method wherein the pressure during the reaction is in the range from 0.1 to 100 bar.

The present invention further provides a method wherein the temperature during the reaction is in the range from −30 to +100° C. and/or the pressure during the reaction is in the range from 0.1 to 100 bar.

The reaction is preferably carried out at a temperature and pressure where the sulfur dioxide comprised in the solvent is in liquid form. It is thus preferable for the sulfur dioxide comprised in the solvent to be in liquid form during the reaction.

The present invention accordingly also provides a method wherein the sulfur dioxide comprised in the solvent is in liquid form during the reaction.

The weight ratio between the aromatic polymer and the solvent is freely choosable. According to the present invention, the weight ratio of the aromatic polymer to the solvent is preferably in the range from 0.1:100 to 1:1, more preferably in the range from 1:100 to 4:10 and most preferably in the range from 3:100 to 2:10.

The present invention accordingly also provides a method wherein the weight ratio of the aromatic polymer to the solvent is in the range from 0.1:100 to 1:1.

As will be readily appreciated, the weight ratio of the aromatic polymer to the solvent relates to the weight ratio of the aromatic polymer to the solvent at the start of the reaction, i.e., before the aromatic polymer has been reacted with the at least one sulfonating agent. During the reaction of the aromatic polymer with the at least one sulfonating agent, the weight ratio between the aromatic polymer and the solvent may change.

The at least one sulfonating agent is likewise usable in any desired amounts. Preferably, the at least one sulfonating agent is used in such amounts that it undergoes complete conversion in the course of the sulfonation reaction of the aromatic polymer.

The reaction may take place in any reactors known to a person skilled in the art as suitable for service at the temperatures and pressures employed in the method of the present invention and whose reactor shell behaves inertly toward the compounds used in the method of the present invention, in particular toward the at least one sulfonating agent and the sulfur dioxide comprised in the solvent. A glass reactor with stirrer assembly is an example of a suitable reactor.

The method of the present invention preferably comprises the steps of:
a) reacting the aromatic polymer with the at least one sulfonating agent comprising sulfur dioxide in the presence of the solvent to obtain the sulfonated aromatic polymer dissolved in the solvent comprising sulfur dioxide,
b) separating the solvent comprising sulfur dioxide from the sulfonated aromatic polymer to obtain the sulfonated aromatic polymer in solid form.

The present invention accordingly also provides a method comprising the steps of:
a) reacting the aromatic polymer with the at least one sulfonating agent in the presence of the solvent to obtain the sulfonated aromatic polymer dissolved in the solvent,
b) separating the solvent from the sulfonated aromatic polymer to obtain the sulfonated aromatic polymer in solid form.

The reaction of the aromatic polymer in step a) is subject to the above-described embodiments and preferences for the reaction mutatis mutandis.

Step a) provides the sulfonated aromatic polymer dissolved in the solvent. Thus, a homogeneous solution of the sulfonated aromatic polymer and the solvent is obtained.

Homogeneous solution is to be understood as meaning that the sulfonated aromatic polymer is present in the solvent dissolved in a molecularly disperse state. The solution may additionally comprise further components, for example unconverted aromatic polymer or residues of the at least one sulfonating agent.

“Residues of the at least one sulfonating agent” is to be understood as meaning not more than 1 wt %, preferably not more than 0.1 wt % and more preferably not more than 0.01 wt % of the at least one sulfonating agent, all based on the total weight of the solution.

The solution comprises typically not more than 1 wt %, preferably not more than 0.1 wt % and more preferably not more than 0.01 wt % of unconverted aromatic polymer, all based on the total weight of the solution.

Step b) comprises separating the solvent from the sulfonated aromatic polymer.

The step of separating the solvent from the sulfonated aromatic polymer in step b) may be effected by any of the procedures known to a person skilled in the art. It is possible, for example, that the step of separating off the solvent in step b) is effected by evaporation.

The present invention accordingly also provides a method wherein the step of separating off the solvent in step b) is effected by evaporation.

The step of separating off the solvent in step b) by evaporation may take place at any desired temperature at which the solvent evaporates. The step of separating off the solvent preferably takes place at a temperature in the range from -20 to +100° C.

The step of separating off the solvent in step b) by evaporation may additionally be carried out at any desired pressure. It is preferably carried out at a pressure in the range from 0.001 to 1 bar.

In a further additionally possible embodiment of the present invention, the step of separating off the solvent in step b) is effected by introducing the sulfonated aromatic polymer dissolved in the solvent into a precipitation bath. In the precipitation bath, the sulfonated aromatic polymer is precipitated.

The precipitation bath comprises at least one further solvent.

“At least one further solvent” is to be understood as meaning for the purposes of the present invention a mixture of two or more further solvents as well as one further solvent.

The at least one further solvent comprised in the precipitation bath is a solvent in which the sulfonated aromatic polymer is but sparingly soluble, if at all. Further solvents of this type are known to a person skilled in the art and include, for example, water and/or alcohols.

The present invention accordingly also provides a method wherein the step of separating off the solvent in step b) is effected by introducing the sulfonated aromatic polymer dissolved in the solvent into a precipitation bath.

The present invention further provides a method wherein the precipitation bath comprises at least one further solvent, wherein the further solvent dissolves the sulfonated aromatic polymer but sparingly, if at all.

The present invention also provides a method wherein the at least one further solvent is selected from the group consisting of water and alcohols.

Mineralized or demineralized water may be used. Mono- and/or dihydric alcohols may be used. The use of monohydric alcohols is preferred. Useful monohydric alcohols include, in particular, methanol, ethanol, 1-propanol and/or 2-propanol.

Introducing the sulfonated aromatic polymer dissolved in the solvent into the precipitation bath precipitates the sulfonated aromatic polymer. The solvent in which the sulfonated aromatic polymer had previously been dissolved may be fully miscible, partially miscible or immiscible with the at least one further solvent. When immiscible, two liquid phases develop; when miscible, by contrast, one homogeneous liquid phase develops.

The precipitated sulfonated aromatic polymer may then be separated from the liquid phase by any procedure known to a person skilled in the art, for example by classification methods, by sieving, filtering or evaporating the liquid phase to obtain the sulfonated aromatic polymer in solid form.

The solvent remaining behind in the precipitation bath together with the at least one further solvent may be separated from the at least one further solvent by any procedure known to a person skilled in the art. Separation preferably takes the form of evaporation.

This evaporation of the solvent to separate it from the at least one further solvent may take place at any desired temperature and at any desired pressure.

The components used in the reaction will now be more particularly described.

Aromatic Polymer

Any aromatic polymer known to a person skilled in the art may be used in the method of the present invention.

“Aromatic polymer” is to be understood in the context of the present invention as meaning a polymer wherein at least one of the monomers from which it has been polymerized has an aromatic ring. Preferably, every monomer used for forming the aromatic polymer has at least one aromatic ring.

Aromatic rings which may be comprised in the monomers are known to a person skilled in the art and include, for example, phenylene groups, such as 1,2-phenylene, 1,3-phenylene and 1,4-phenylene, naphthylene groups, for example 1,6-naphthylene, 1,7-naphthylene, 2,6-naphthylene and 2,7-naphthylene, and also the aromatic rings derived from anthracene, phenanthrene and naphthacene.

The aromatic polymer is, for example, selected from the group consisting of aromatic polyamides, aromatic polyimides, polyarylene ethers, aromatic polycarbonates, aromatic polysulfides, aromatic polysulfoxides, polyarylene ether sulfones, aromatic polyesters and polystyrenes and also copolymers formed from two or more thereof. The aromatic polymer is preferably selected from the group consisting of polyarylene ethers.

The present invention accordingly also provides a method wherein the aromatic polymer is selected from the group consisting of aromatic polyamides, aromatic polyimides, polyarylene ethers, aromatic polycarbonates, aromatic polysulfides, aromatic polysulfoxides, polyarylene ether sulfones, aromatic polyesters and polystyrenes and also copolymers formed from two or more thereof.

Polyarylene ethers are known per se to a person skilled in the art. The aromatic polymer is preferably a polyarylene ether comprising building blocks of general formula (I)

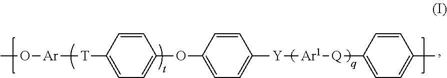

where
t and q are each independently 0, 1, 2 or 3,
Q, T and Y are each independently a chemical bond or a group selected from —O—, —S—, —SO₂—, S═O, C═O, —N═N— and —CR^{a}R^{b}—, where R^{a} and R^{b} are each independently a hydrogen atom or a C₁-C₁₂ alkyl, C₁-C₁₂ alkoxy or C₆-C₁₈ aryl group, and wherein at least one of Q, T and Y is —SO₂— and
Ar and Ar¹ are each independently an arylene group having from 6 to 18 carbon atoms.

The present invention accordingly also provides a method wherein the aromatic polymer is a polyarylene ether comprising building blocks of general formula (I)

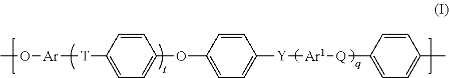

where
t and q are each independently 0, 1, 2 or 3,
Q, T and Y are each independently a chemical bond or a group selected from —O—, —S—, —SO₂—, S═O, C═O, —N═N— and —CR^{a}R^{b}—, where R^{a} and R^{b} are each independently a hydrogen atom or a C₁-C₁₂ alkyl, C₁-C₁₂ alkoxy or C₆-C₁₈ aryl group, and
Ar and Ar¹ are each independently an arylene group having from 6 to 18 carbon atoms.
When Q, T or Y is a chemical bond under the above-recited conditions, this is to be understood as meaning that a chemical bond links the neighboring groups to the left and right together directly.

Preferably, however, Q, T and Y in formula (I) are each independently selected from —O— and —SO₂— subject to the proviso that at least one of the group consisting of Q, T and Y is —SO₂—.

When at least one of the group consisting of Q, T and Y is —SO₂—, the polyarylene ether comprising building blocks of general formula (I) will be a polyarylene ether sulfone.

It will be readily appreciated that at least one of the group consisting of Q, T and Y being —SO₂— means that at least one of 0, T and Y in formula (I) is —SO₂—. The consequence is, for example, that when q is =0, at least one of T and Y is —SO₂—; when, for example, t is =0, at least one of Q and Y is —SO₂—.

It is accordingly preferable for the purposes of the present invention that the polyarylene ether be a polyarylene ether sulfone comprising building blocks of general formula (I), where at least one of Q, T and Y is —SO₂.

The present invention accordingly also provides a method wherein the polyaryl ether is a polyarylene ether sulfone comprising building blocks of general formula (I) where at least one of Q, T and Y is —SO₂—.

When Q, T or Y are —CR^{a}R^{b}—, R^{a} and R^{b} are each independently a hydrogen atom or a C₁-C₁₂ alkyl, C₁-C₁₂ alkoxy or C₆-C₁₈ aryl group.

Preferred C₁-C₁₂ alkyl groups include linear and branched, saturated alkyl groups having from 1 to 12 carbon atoms. The following moieties are suitable in particular: C₁-C₆ alkyl, such as methyl, ethyl, n-propyl, i-propyl, n-butyl, sec-butyl, 2- or 3-methylpentyl and longer-chain moieties such as unbranched heptyl, octyl, nonyl, decyl, undecyl, lauryl and the singly or multiply branched analogs thereof.

The alkyl moieties in the aforementioned usable C₁-C₁₂ alkoxy groups include the above-defined alkyl groups having from 1 to 12 carbon atoms. Preferentially employable cycloalkyl moieties include, in particular, C₃-C₁₂ cycloalkyl moieties, for example cyclopropyl, cyclobutyl, cyclopentyl, cyclohexyl, cycloheptyl, cyclooctyl, cyclopropylmethyl, cyclopropylethyl, cyclopropylpropyl, cyciobutylmethyl, cyclobutylethyl, cyclopentylethyl, cyclopentylpropyl, cyclopentylbutyl, cyclopentylpentyl, cyclopentylhexyl, cyclohexylmethyl, cyclohexyldimethyl and cyclohexyltrimethyl.

Ar and Ar¹ are each independently a C₆-C₁₈ arylene group. Ar preferably derives from an electron-rich aromatic substance very susceptible to electrophilic attack, preferably selected from the group consisting of hydroquinone, resorcinol, dihydroxynaphthalene, in particular 2,7-dihydroxynaphthalene, and 4,4′-bisphenol. Ar¹ is preferably an unsubstituted C₆ or C₁₂ arylene group.

As C₆-C₁₈ arylene groups Ar and Ar¹ there may be used, in particular, phenylene groups, such as 1,2-, 1,3- and 1,4-phenylene, naphthylene groups, for example 1,6-, 1,7-, 2,6- and 2,7-naphthylene, and also the anthracene-, phenanthrene- and naphthacene-derived arylene groups.

In the preferred embodiment of formula (I), Ar and Ar¹ are each preferably independently selected from the group consisting of 1,4-phenylene, 1,3-phenylene, naphthylene, in particular 2,7-dihydroxynaphthylene, and 4,4′-bisphenylene.

Preferred polyarylene ethers comprise at least one of the following building blocks la to lo as structural repeat units:

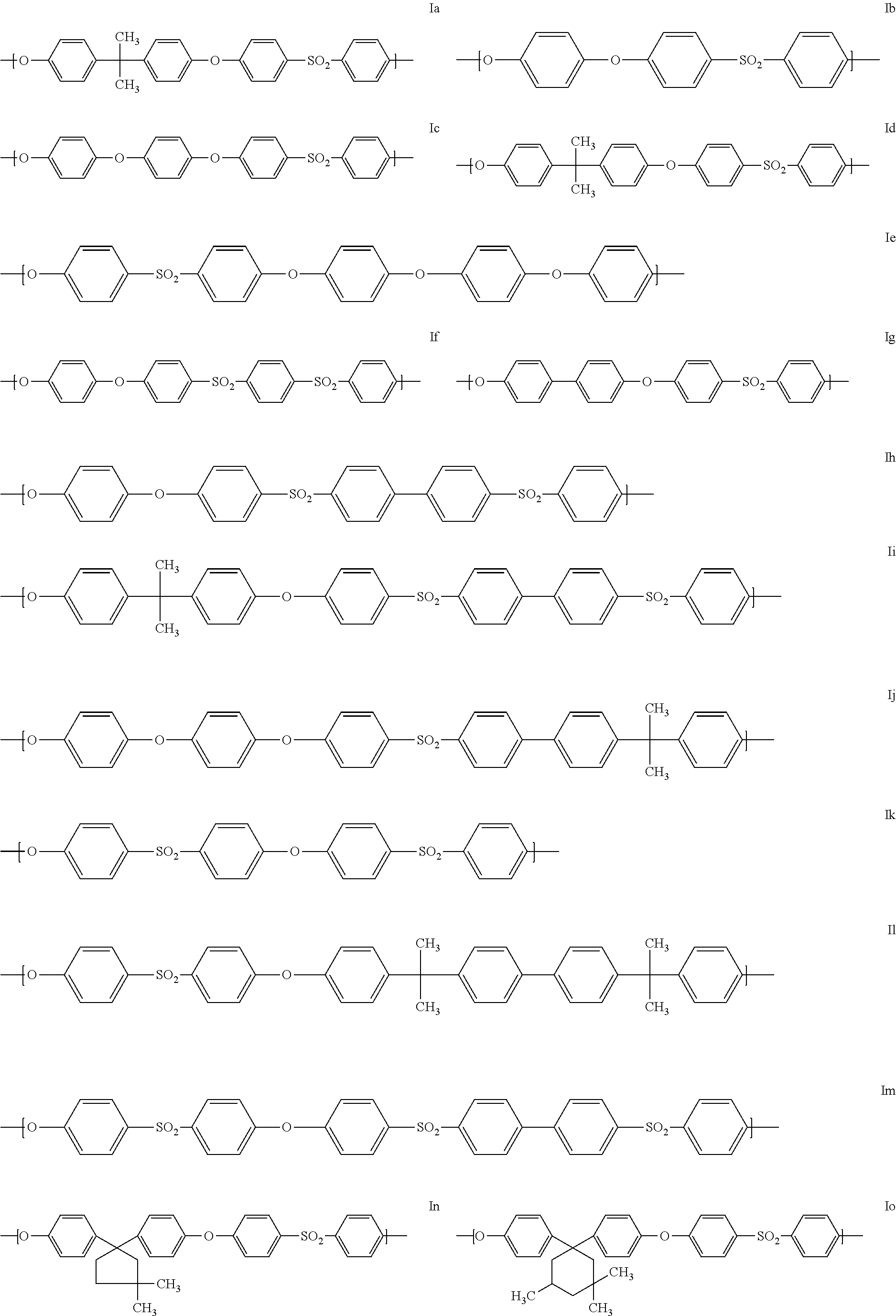

In addition to the preferred building blocks Ia to Io, preference is also given to building blocks in which one or more 1,4-phenylene units deriving from hydroquinone are replaced by 1,3-phenylene units derived from resorcinol or by naphthylene units derived from dihydroxynaphthalene.

The building blocks Ia, Ig and Ik are particularly preferable as building blocks of general formula (I). It is also particularly preferable for the polyarylene ethers of component (A) to be constructed essentially of at least one variety of building blocks of general formula (I), in particular of at least one building block selected from Ia, Ig and Ik.

In a particularly preferred embodiment, Ar is =1,4-phenylene, t is =1, q is =0, T is a chemical bond and Y is ═SO₂. Particularly preferred polyarylene ether sulfones (A) constructed of the aforementioned repeat unit are referred to as polyphenylene sulfone (PPSU) of formula Ig.

In a further particularly preferred embodiment, Ar is =1,4-phenylene, t is =1, q is =0, T is ═C(CH₃)₂ and Y is ═SO₂. Particularly preferred polyarylene ether sulfones (A) constructed of the aforementioned repeat unit are referred to as polysulfone (PSU) of formula Ia.

In a further particularly preferred embodiment, Ar is =1,4-phenylene, t is =1, q is =0, T is =Y is ═SO₂. Particularly preferred polyarylene ether sulfones constructed of the aforementioned repeat unit are referred to as polyether sulfone (PESU) of formula Ik.

Abbreviations such as PPSU, PESU and PSU in the context of the present invention comply with DIN EN ISO 1043-1 (Plastics—Symbols and Abbreviated terms—Part 1: Basic polymers and their special characteristics (ISO 1043-1:2001); German version of EN ISO 1043-1:2002).

It is preferable for the purposes of the present invention for the aromatic polymer to comprise building blocks selected from the group consisting of polysulfone units (PSU units), polyether sulfone units (PESU units) and polyphenylene sulfone units (PPSU units).

It is particularly preferable for the purposes of the present invention for the aromatic polymer to be selected from the group consisting of polysulfones (PSU), polyether sulfones (PESU), polyphenylene sulfone (PPSU) and copolymers thereof.

The present invention accordingly also provides a method wherein the aromatic polymer is selected from the group consisting of polysulfones (PSU), polyether sulfones (PESU), polyphenylene sulfones (PPSU) and copolymers thereof.

It is particularly preferable for the aromatic polymer to be a copolymer formed from polyether sulfone (PESU) and polyphenylene sulfone (PPSU).

The present invention accordingly also provides a method wherein the aromatic polymer is a copolymer formed from polyether sulfone (PESU) and polyphenylene sulfone (PPSU).

When the aromatic polymer is a copolymer formed from polyether sulfone (PESU) and polyphenylene sulfone (PPSU), this copolymer may be, for example, a random copolymer or a block copolymer. Preference is given to a random copolymer formed from polyether sulfone (PESU) and polyphenylene sulfone (PPSU).

When the aromatic polymer is a copolymer formed from polyether sulfone (PESU) and polyphenylene sulfone (PPSU), this copolymer comprises for example from 1 to 20 mol % of polyphenylene sulfone (PPSU) and from 80 to 99 mol % of polyether sulfone (PESU), all based on the total amount-of-substance amount of the copolymer.

The weight-average molecular weights M_{w} of the polyarylene ethers are preferably in the range from 10 000 to 150 000 g/mol, in particular in the range from 15 000 to 120 000 g/mol and more preferably in the range from 18 000 to 100 000 g/mol, as determined via gel permeation chromatography in dimethylacetamide as solvent versus narrowly distributed polymethyl methacrylate as standard.

Production methods leading to the aforementioned polyarylene ethers are known per se to a person skilled in the art and described, for example, in Herman F. Mark, “Encyclopedia of Polymer Science and Technology”, third edition, volume 4, 2003, chapter “Polysulfones” on pages 2 to 8 and also in Hans R. Kricheldorf, “Aromatic Polyethers” in: Handbook of Polymer Synthesis, second edition, 2005 on pages 427 to 443.

Stagnating Agent

The at least one sulfonating agent is suitably any compound known to a person skilled in the art that is capable of introducing an SO₂X group, where X is Cl or OZ, where Z is selected from the group consisting of H, Li, Na, K, Mg, Ca and NH₄, into the aromatic ring of the aromatic polymer. The SO₂X group is preferably a sulfonic acid group (—SO₃H) or a group capable of reacting with water to form a sulfonic acid group. Groups of this type are known to a person skilled in the art and include, for example, chlorosulfonyl groups (—SO₂Cl). The SO₂X group is more preferably therefore a sulfonic acid group (—SO₃H) or a chlorosulfonyl group (—SO₂Cl), most preferably the SO₂X group is a sulfonic acid group (—SO₃H).

It is preferable for the purposes of the present invention for the at least one sulfonating agent to be selected from the group consisting of chlorosulfonic acid, sulfur trioxide, sulfuric acid, fuming sulfuric acid and polyalkylbenzenesulfonic acid. It is more preferable for the at least one sulfonating agent to be selected from the group consisting of sulfur trioxide, sulfuric acid, fuming sulfuric acid and polyalkylbenzenesulfonic acids. It is particularly preferable for the at least one sulfonating agent to be sulfur trioxide.

It is thus particularly preferable for the purposes of the present invention to use one sulfonating agent and this to be sulfur trioxide.

The present invention accordingly also provides a method wherein at least one sulfonating agent is selected from the group consisting of chlorosulfonic acid, sulfur trioxide, sulfuric acid, fuming sulfuric acid and polyalkylbenzenesulfonic acids.

The present invention further provides a method wherein at least one sulfonating agent is sulfur trioxide.

It will be appreciated that when chlorosulfonic acid is used as the at least one sulfonating agent, chlorosulfonyl groups will be introduced as SO₂X groups into the aromatic ring of the aromatic polymer, and they can then be converted into sulfonic acid groups by reaction with water.

When sulfur trioxide, sulfuric acid, fuming sulfuric acid and/or polyalkylbenzenesulfonic acid is employed as the at least one sulfonating agent, sulfonic acid groups will be introduced as SO₂X groups into the aromatic ring of the aromatic polymer.

Solvent

According to the present invention, the solvent comprises sulfur dioxide. In addition, the solvent may further comprise additional solvents. Suitable additional solvents are solvents which dissolve the aromatic polymer and also the at least one sulfonating agent and are completely miscible with sulfur dioxide.

As additional solvent there may be employed for example cyclic sulfone compounds such as sulfolane and/or dialkyl sulfones such as dimethyl sulfoxide and dibutyl sulfoxide. It is further possible to use, for example, sulfuric acid as additional solvent. Sulfuric acid is used as additional solvent in particular when the sulfonating agent used is sulfuric acid.

It is preferable for the purposes of the present invention for the solvent to comprise not less than 80 wt % of sulfur dioxide, based on the total weight of the solvent. The solvent comprises more preferably not less than 90 wt % and yet more preferably not less than 95 wt % of sulfur dioxide, both based on the total weight of the solvent.

It is most preferable for the solvent to consist of sulfur dioxide.

The most preferred option according to the present invention is thus not to use any additional solvent.

The present invention accordingly also provides a method wherein the solvent comprises not less than 80 wt % of sulfur dioxide, based on the total weight of the solvent.

Sulfonated Aromatic Polymer

The reaction of the aromatic polymer with the at least one sulfonating agent in the method of the present invention sulfonates at least one of the aromatic rings of the aromatic polymer at least partially.

The mechanism of the sulfonation reaction is known as such to a person skilled in the art. In a sulfonation reaction, a hydrogen atom on the aromatic ring is replaced by an SO₂X group, where X is Cl or OZ, where Z is selected from the group consisting of H, Li, Na, K, Mg, Ca and NH₄. An SO₂X group is preferably a sulfonic acid group (—SO₃H) or a group capable of reacting with water to form a sulfonic acid group (—SO₃H). It is particularly preferable for the SO₂X group to be a sulfonic acid group (—SO₃H).

It is thus particularly preferable for the sulfonation reaction to replace a hydrogen atom on the aromatic ring by a sulfonic acid group (—SO₃H).

The present invention also provides a sulfonated aromatic polymer obtainable by the method of the present invention.

Typically from 0.001 to 1, preferably from 0.005 to 0.1 and more preferably from 0.01 to 0.08 SO₂X groups per aromatic ring is introduced into the aromatic polymer. The sulfonated aromatic polymer therefore typically has from 0.001 to 1, preferably from 0.005 to 0.1 and more preferably from 0.01 to 0.08 sulfonic acid groups per aromatic ring.

The present invention accordingly also provides a sulfonated aromatic polymer wherein the sulfonated aromatic polymer has from 0.001 to 1 SO₂X groups, where X is Cl or OZ, where Z is hydrogen or a cation equivalent, per aromatic ring.

The number of SO₂X groups per aromatic ring is determined by averaging over all the aromatic rings of the sulfonated aromatic polymer. To this end, the number of SO₂X groups in the sulfonated aromatic polymer is divided by the number of aromatic rings in the sulfonated aromatic polymer. Methods of determining the number of SO₂X groups and the number of aromatic rings, each in the sulfonated aromatic polymer, are known to a person skilled in the art. The number of SO₂X groups is determinable, for example, by acid-base titration or by spectroscopic methods such as H NMR spectroscopy or IR spectroscopy (infrared spectroscopy). Sulfonated aromatic polymers having SO₂X groups on the aromatic ring display characteristic peaks and bands, making it possible to determine the number of SO₂X groups per aromatic ring. The ratio of sulfonated to nonsulfonated aromatic rings can also be determined by these methods, in particular by H NMR spectroscopy.

In the context of the present invention, X in “SO₂X group” is Cl or OZ, where Z is selected from the group consisting of H, Li, Na, K, Mg, Ca and NH₄. An SO₂X group is preferably a sulfonic acid group (—SO₃H) or a group capable of reacting with water to form a sulfonic acid group (—SO₃H), for example a chlorosulfonyl group (—SO₂Cl). It is therefore particularly preferable for the SO₂X group to be a sulfonic acid group (—SO₃H) or a chlorosulfonyl group (—SO₂Cl), most preferably the SO₂X group is a sulfonic acid group (—SO₃H).

When the aromatic polymer has aromatic rings which differ in their degrees of substitution it is thus typically the case that the strongest nucleophilic aromatic rings are preferentially sulfonated.

When, in a preferred embodiment, the aromatic polymer is, for example, a copolymer formed from polyether sulfone (PESU) and polyphenylene sulfone (PPSU), the aromatic rings of the biphenylene units of the polyphenylene sulfone (PPSU) are more nucleophilic than the aromatic rings of the biphenyl sulfone units of the copolymer. During the reaction of the aromatic polymer, then, the aromatic rings of the biphenylene units of the polyphenylene sulfone (PPSU) are sulfonated preferentially.

The sulfonation of the aromatic rings of the biphenylene units of the polyphenylene sulfone (PPSU) typically takes place in positions 3 and/or 3′.

In one preferred embodiment of the present invention, therefore, the sulfonated aromatic polymer comprises at least one building block selected from the group consisting of building blocks of general formula (II) and building blocks of general formula (III).

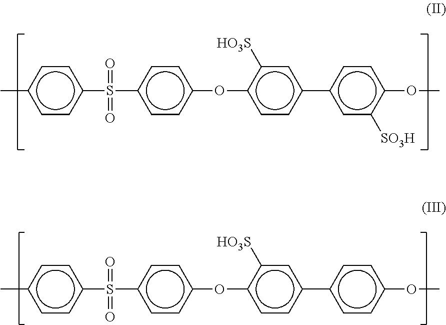

The present invention accordingly also provides a sulfonated aromatic polymer comprising at least one building block selected from the group consisting of building blocks of general formula (II) and building blocks of general formula (III).

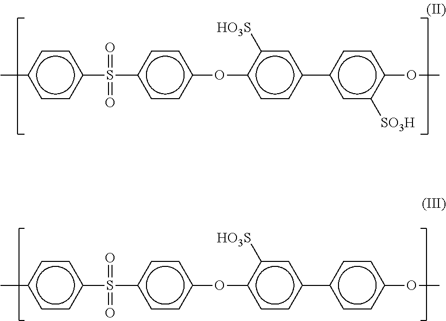

The sulfonated aromatic polymer preferably has a number-average molecular weight (Mₙ) in the range from 10 000 to 35 000 g/mol, as determined by gel permeation chromatography in dimethylacetamide as solvent versus narrowly distributed polymethyl methacrylate as standard.

Use

The present invention further provides the method of using the sulfonated aromatic polymer of the present invention in the manufacture of membranes.

The sulfonated aromatic polymer of the present invention is preferably used for membranes for ultrafiltration, microfiltration, reverse osmosis and/or forward osmosis.

Methods of manufacturing membranes from the sulfonated aromatic polymer of the present invention are known per se to a person skilled in the art.

A method of manufacturing such a membrane typically comprises the steps of:
i) providing a solution comprising the sulfonated aromatic polymer of the present invention and at least one aprotic polar solvent, and
ii) separating the sulfonated aromatic polymer of the present invention from the aprotic polar solvent to obtain a membrane.

To increase the hydrophilicity of such a membrane, at least one hydrophilic polymer may be admixed to the solution provided in step i). One example of a suitable hydrophilic polymer is polyvinylpyrrolidone having a weight-average molecular weight (M_{W}) in the range from 10 000 to 2 000 000 g/mol, preferably in the range from 200 000 to 1 600 000 g/mol.

Preferably, therefore, a method of manufacturing a membrane comprises the steps of:
i) providing a solution comprising the sulfonated aromatic polymer of the present invention, at least one hydrophilic polymer and at least one aprotic polar solvent, and
ii) separating the mixture of the sulfonated aromatic polymer of the present invention and the hydrophilic polymer from the aprotic polar solvent to form a membrane.

Step i) thus comprises providing a solution of the sulfonated aromatic polymer and optionally of the hydrophilic polymer in an aprotic polar solvent. Aprotic polar solvents considered for use are those in which the sulfonated aromatic polymer is soluble, where “soluble” is to be understood in this context as meaning that at room temperature (20° C.) not less than 10 wt %, preferably not less than 20 wt % and more preferably not less than 25 wt % of the sulfonated aromatic polymer dissolves, all based on the total weight of the solution in the aprotic polar solvent.

“A sulfonated aromatic polymer” is to be understood in the context of the present invention as meaning a mixture of two or more sulfonated aromatic polymers as well as one sulfonated aromatic polymer. Such a mixture of two or more sulfonated aromatic polymers is also referred to as a blend.

Preferably, the solution obtained in step i) is devolatilized prior to the execution of step ii). Devolatilization methods are known to a person skilled in the art.

The aprotic polar solvent in step i) is preferably selected from the group consisting of N-methylpyrrolidone, dimethylacetamide, dimethyl sulfoxide, dimethylformamide, sulfolane (tetrahydrothiophene 1,1-dioxide) and mixtures thereof. The aprotic polar solvent is more preferably selected from the group consisting of N-methylpyrrolidone, dimethylacetamide, dimethyl sulfoxide, dimethylformamide and mixtures thereof.

The solution in step i) is obtainable in customary receptacles, in particular in receptacles comprising a stirring device and preferably a temperature control device. Preparing the solution as per step i) is preferably effected under agitation. The step of dissolving the sulfonated aromatic polymer of the present invention and optionally the hydrophilic polymer may be effected concurrently or in succession.

The duration of step i) may vary between wide limits, preferably the duration of step i) is in the range from 10 minutes to 48 hours, especially from 10 minutes to 12 hours, more preferably from 15 minutes to 6 hours. The duration of step i) is typically adjusted such that a homogeneous solution of the sulfonated aromatic polymer according to the present invention and optionally of the hydrophilic polymer in the aprotic polar solvent is obtained.

The temperature during step i) is preferably in the range from 20 to 120° C., more preferably in the range from 40 to 100° C. The concentration of the sulfonated aromatic polymer according to the present invention and optionally of the hydrophilic polymer in the aprotic polar solvent depends in particular on the manner of performing step ii).

The solution provided in step i) comprises with preference from 5 to 40 wt % and with particular preference from 10 to 30 wt % of the sulfonated aromatic polymer according to the present invention, based on the total weight of the solution.

When the solution provided in step i) further comprises a hydrophilic polymer, the sum total of the weight percentages of the sulfonated aromatic polymer according to the present invention and of the hydrophilic polymer is preferably in the range from 5 to 40 wt % and more preferably in the range from 10 to 30 wt %, all based on the total weight of the solution. In this case, the weight percentage ratio of the sulfonated aromatic polymer according to the present invention to the hydrophilic polymer in the solution in step i) is generally in the range from 98:2 to 50:50.

This is followed by step ii) of separating the sulfonated aromatic polymer of the present invention, or the mixture of the sulfonated aromatic polymer and the hydrophilic polymer, from the aprotic polar solvent to obtain the membrane. The membrane may have any shape known to a person skilled in the art. The membrane is preferably a sheet, a layer on a base, or a fiber.

For example, to effect the separation in step ii), the solution of the sulfonated aromatic polymer, optionally the hydrophilic polymer and the aprotic polar solvent may be cast into a film and this film may then for example be introduced into a precipitation bath and/or dried to obtain the membrane.

The present invention will now be more particularly described by means of examples without however restricting it thereto.

### EXAMPLES

### Example 1

The aromatic polymer used was a random polyether sulfone-polyphenylene sulfone copolymer (PESU-PPSU copolymer) having a polyphenyl sulfone fraction of 10 mol %, based on the total amount-of-substance amount of the aromatic polymer. The viscosity number (VN) was measured to DIN ISO 1628-1 in a 1 wt % NMP solution at 25° C. The viscosity number of the copolymer was 52 ml/g.

The aromatic polymer was dissolved at 20 wt %, based on the combined weight of aromatic polymer and sulfur dioxide, in liquid sulfur dioxide at −15° C. and 1 bar (ambient pressure).

Then, 0.9 wt % of sulfur trioxide was admixed and the mixture was reacted at −15° C. for 5 hours. Then, the sulfur dioxide and also any sulfur trioxide still present were separated from the sulfonated aromatic polymer obtained by evaporating the sulfur dioxide and also any sulfur trioxide present at 65° C. and a pressure of 1 bar (ambient pressure) for 1 hour.

The viscosity number of the sulfonated aromatic polymer obtained was 53 ml/g. The degree of sulfonation (number of sulfonic acid groups per aromatic ring) of the copolymer was determined using H NMR spectroscopy and IR spectroscopy.

The H NMR spectroscopy measurements were carried out with an Agilent Technologies MR 400 DD2, 400 MHz, in dimethyl sulfoxide-d6, at 23° C. The degree of sulfonation was determined from the ratio of the aromatic protons adjacent to the sulfonic acid group (δ=8.13 ppm, singlet) relative to the protons ortho to the sulfone bridges (δ=8.03 ppm and δ=8.01 ppm, doublet). The sulfonated aromatic polymer was shown by H NMR spectroscopy to contain 0.015 sulfonic acid groups per aromatic ring.

The IR spectroscopy measurements were carried out using a Nicolet 6700 FTIR. The sulfonated aromatic polymer was dissolved in DMF dimethylformamide, applied as a film to KRS5 windows and vacuum dried at 160° C. After cooling down to room temperature (25° C.), the film was measured in transmission. The spectrum of the sulfonated aromatic polymer has a characteristic band at v=1023 cm⁻¹ for the SO₃ group. The number of SO₃H groups introduced can be identified from the ratio of the band area at v=1023 cm⁻¹ relative to the reference band at v=1012 cm⁻¹ after calibration. Calibration was performed using sulfonated aromatic polymers having a known degree of sulfonation (sulfonated aromatic polymers having a known degree of sulfonation were obtainable for example by synthesis of sulfonated aromatic polymers using monomers having a known degree of sulfonation). The sulfonated aromatic polymer was shown by IR spectroscopy to contain 0.021 sulfonic acid groups per aromatic ring.

### Comparatty Example 2

The aromatic polymer used is the PESU-PPSU copolymer of Example 1.

The aromatic polymer is mixed 20 wt %, based on the combined weight of aromatic polymer and sulfolane, and at 25° C. and 1 bar (ambient pressure) with sulfolane and admixed with sulfur trioxide. The viscous mixture obtained is maintained at 25° C. and 1 bar (ambient pressure) for 5 hours.

After the sulfur trioxide and sulfolane have been removed, it is not a sulfonated aromatic polymer which is obtained, but only the originally employed aromatic polymer.

It is clearly seen that a sulfonation of the aromatic polymer in sulfolane with sulfur trioxide is not possible even at room temperature (25° C.).

### Comparative Example 3

The aromatic polymer used is the PESU-PPSU copolymer of Example 1.

The aromatic polymer is dissolved at 20 wt %, based on the combined weight of aromatic polymer and sulfolane, in sulfolane at 85° C. and 1 bar (ambient pressure) and admixed with sulfur trioxide.

The solution obtained is highly viscous and but difficult to process, especially react.

When sulfolane instead of sulfur dioxide is used as solvent, solutions comprising higher concentrations of aromatic polymer cannot be reacted, since but very highly viscous solutions form even at high temperatures of, for example, 85° C.

### Comparative Example 4

The aromatic polymer used is the PESU-PPSU copolymer of Example 1.

The aromatic polymer is dissolved at 8 wt %, based on the combined weight of aromatic polymer and sulfolane, in sulfolane at 90° C. and 1 bar (ambient pressure).

Then, sulfur trioxide is admixed and the mixture is reacted at 90° C. for 1 hour.

Removing the sulfolane and also any sulfur trioxide still present from the sulfonated aromatic polymer obtained in the reaction by evaporation of sulfolane and sulfur trioxide is but scarcely possible, since sulfolane has but a low volatility and the mixture obtained in the reaction decomposes at higher temperatures. When lower temperatures are used, the evaporation times become uneconomically long, resulting in incomplete removal of sulfolane. Removal is therefore effected by the reaction mixture obtained being first dissolved in N-methylpyrrolidone and then precipitated in ethanol. After filtration, the precipitate obtained is washed in a hot-water extraction at 90° C. for 20 h (hours) and vacuum dried at 150° C. for 15 h.

The residual sulfolane content of the sulfonated aromatic polymer is 0.7 wt % of sulfolane, based on the weight of the sulfonated aromatic polymer.

### Comparative Example 5

The aromatic polymer used is the PESU-PPSU copolymer of Example 1.

The aromatic polymer is dissolved at 8 wt %, based on the combined weight of aromatic polymer and sulfuric acid, in concentrated sulfuric acid (98 wt % in water) at 50° C. The mixture is reacted at 80° C. and 1 bar (ambient pressure) for 5 hours.

The sulfonated aromatic polymer obtained after separation has a 20% lower molecular weight than the aromatic polymer used. This shows that some chain degradation takes place on sulfonating in sulfuric acid.

### Comparative Example 6

The aromatic polymer used is the PESU-PPSU copolymer of Example 1.

The aromatic polymer is dissolved at 10 wt %, based on the combined weight of aromatic polymer and sulfolane, in sulfolane at 90° C. and 1 bar (ambient pressure).

Then, a stoichiometric amount of concentrated sulfuric acid (98 wt % in water) for a 20% degree of sulfonation of the aromatic polymer is admixed and the mixture obtained is reacted at 90° C. for 1 hour.

The product obtained is separated off by precipitation in ethanol. H NMR spectroscopy studies show that no sulfonated aromatic polymer is obtained. The H NMR spectrum obtained is that of the originally employed aromatic polymer.

### Comparative Example 7

The aromatic polymer used is the PESU-PPSU copolymer of Example 1.

The aromatic polymer is dissolved at 10 wt %, based on the combined weight of aromatic polymer and sulfolane, in sulfolane at 90° C. and 1 bar (ambient pressure).

Then, a stoichiometric amount of concentrated sulfuric acid (98 wt % in water) for a 100% degree of sulfonation of the aromatic polymer is admixed and the mixture obtained is reacted at 90° C. for 1 hour.

The product obtained is separated off by precipitation in ethanol. H NMR spectroscopy studies show that no sulfonated aromatic polymer is obtained. The H NMR spectrum obtained is that of the originally employed aromatic polymer.

### Comparative Example 8

The aromatic polymer used is the PESU-PPSU copolymer of Example 1.

The aromatic polymer is dissolved at 10 wt %, based on the combined weight of aromatic polymer and sulfolane, in sulfolane at 90° C. and 1 bar (ambient pressure).

Then, a 5-fold stoichiometric excess of concentrated sulfuric acid (98 wt % in water) for a 100% degree of sulfonation of the aromatic polymer is admixed and the mixture obtained is reacted at 90° C. for 1 hour.

The product obtained is separated off by precipitation in ethanol. H NMR spectroscopy studies show that no sulfonated aromatic polymer is obtained. The H NMR spectrum obtained is that of the originally employed aromatic polymer.

Comparative Examples 6, 7 and 8 show that the reactivity of concentrated sulfuric acid as a sulfonating agent in purely sulfolane as solvent is even at temperatures of 90° C. insufficient to sulfonate the aromatic polymer.

1.-12. (canceled)

13. A method of forming a sulfonated aromatic polymer by reacting an aromatic polymer with at least one sulfonating agent in the presence of a solvent comprising sulfur dioxide, where the aromatic polymer is a polyarylene ether comprising building blocks of general formula (I) 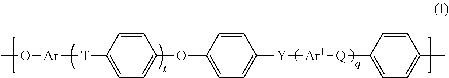
where
t and q are each independently 0, 1, 2 or 3,
Q, T and Y are each independently a chemical bond or a group selected from the group consisting of —O—, —S—, —SO₂—, S═O, C═O, —N═N— and —CR^{a}R^{b}—, where R^{a} and R^{b} are each independently a hydrogen atom or a C₁-C₁₂ alkyl, C₁-C₁₂ alkoxy or C₆-C₁₈ aryl group, and
Ar and Ar¹ are each independently an arylene group having from 6 to 18 carbon atoms,
wherein the at least one sulfonating agent is selected from the group consisting of sulfur trioxide, sulfuric acid, fuming sulfuric acid and polyalkylbenzenesulfonic acids, and
wherein the solvent comprises not less than 80 wt % of sulfur dioxide, based on the total weight of the solvent.

14. The method according to claim 13 wherein the polyaryl ether is a polyarylene ether sulfone comprising building blocks of general formula (I) where at least one of Q, T and Y is —SO₂—.

15. The method according to claim 13 wherein the aromatic polymer is selected from the group consisting of polysulfones (PSU), polyether sulfones (PESU), polyphenylene sulfones (PPSU) and copolymers thereof.

16. The method according to claim 13 wherein the at least one sulfonating agent is sulfur trioxide.

17. The method according to claim 13 wherein the weight ratio of the aromatic polymer to the solvent is in the range from 0.1:100 to 1:1.

18. The method according to claim 13 wherein the sulfur dioxide comprised in the solvent is in liquid form during the reaction.

19. The method according to claim 13 wherein the temperature during the reaction is in the range from —30 to +100° C. and/or the pressure during the reaction is in the range from 0.1 to 100 bar.

20. The method according to claim 13 wherein the method comprises the steps of:
a) reacting the aromatic polymer with the at least one sulfonating agent in the presence of the solvent to obtain the sulfonated aromatic polymer dissolved in the solvent, separating the solvent from the sulfonated aromatic polymer to obtain the sulfonated aromatic polymer in solid form.

21. The method according to claim 20 wherein the step of separating off the solvent in step b) is effected by evaporation.

22. A sulfonated aromatic polymer obtained by the method according to claim 13.

23. The sulfonated aromatic polymer according to claim 22 wherein the sulfonated aromatic polymer has from 0.001 to 1 SO₂X groups, where X is Cl or OZ, where Z is hydrogen or a cation equivalent, per aromatic ring.

24. A method comprising utilizing the sulfonated aromatic polymer according to claim 22 in the manufacture of membranes.
